(19) United States
(12) Patent Application Publication
(10) Pub. No.: US 2026/0246639 A1
(43) Pub. Date: Aug. 20, 2026

(54) Method for an Interaction With a Hardware Token

(71) Applicant: Bayerische Motoren Werke Aktiengesellschaft, Muenchen (DE)

(72) Inventors: Matthias FINK, Muenchen (DE); Marco HIPPLER, Muenchen (DE)

(21) Appl. No.: 19/542,758

(22) Filed: Feb. 18, 2026

(30) Foreign Application Priority Data
Feb. 19, 2025 (DE) 10 2025 106 201.3

(51) Int. Cl. H04L 9/32

(52) U.S. Cl. CPC H04L 9/3213; H04L 9/3226; H04L 9/3263

(57) ABSTRACT

A method for an interaction with a hardware token includes searching for an identification code based on a digital certificate and initiating the interaction with the hardware token based on the identification code.

### CROSS REFERENCE TO RELATED APPLICATION

This application claims priority under 35 U.S.C. §119 from German Patent Application No. 10 2025 106 201.3, filed February 19, 2025, the entire disclosure of which is herein expressly incorporated by reference.

### BACKGROUND AND SUMMARY

The invention relates to a method for an interaction with a hardware token, such as a smart card. In particular, the invention relates to a method for a password-protected interaction with a hardware token, for example, in order to provide, overwrite, etc. an end point for a digital key on the hardware token.

Digital keys, in particular vehicle keys, are known as such. In this regard, with “Digital Key Release 3”, the Car Connectivity Consortium (CCC) defines a standard for a digital vehicle key in the form of a technical specification. In this context, an application or app of a vehicle manufacturer or a service provider may be installed, for instance, on an end device of a vehicle owner, which application or app enables access to a vehicle, the control of particular vehicle functions, etc. via a digital vehicle key held on the device (for instance in a secure memory of the device).

The use of the key is based on interfaces between the secure memory and an operating system of the device, and between the operating system and other applications (apps), which are executed on the device. Usage options are moreover expanded due to the presence of a backend system for key management, i.e., the management of the digital key. Key management links end devices to the vehicle and enables key sharing and further services.

More precisely, a digital (vehicle) key may be generated, for example, by pairing an end device with a vehicle. In a CCC context, such a process is referred to as owner pairing. A prerequisite for this is that evidence of ownership is produced in relation to the vehicle, e.g., through simultaneous presentation of two key fobs.

A digital key may moreover be transferred from one device to another (key sharing), for example, from one user to another user (for instance in the case of private use), from a backend system to a user (in the case of commercial server-to-user use, for example), from a user to a backend system (in the case of so-called service activation, as specified by the CCC) or from backend system to backend system. According to the CCC, for example, corresponding signaling involves an end device or multiple end devices, a device-manufacturer server, a vehicle-manufacturer server and a vehicle, and possibly a separate service-provider server for server-based key sharing.

It is furthermore generally known that a digital key may not only be stored on an end device such as a smartphone, but also on a hardware token, for example, a smart card, chip card, etc. An interaction between the smart card and the vehicle may take place, for example, via NFC (near field communication) technology.

Concepts for smart cards with CCC-compatible digital keys also exist, although methods for key sharing to a smart card are not yet in practical use. A concept for a smart card with a digital key, in which a smart card or a card of a particular card type is provided by the vehicle manufacturer as an additional static vehicle key, is currently standardized by the CCC. A card of a different card type may be acquired by a vehicle owner in order to optionally store a key on the card and delete it again.

Although security measures are also provided in order to prevent unauthorized storage or deletion of the key on the card, there is still a general need for an improved security concept which reliably prevents the unauthorized storage or deletion of digital keys on smart cards on the one hand, without hampering or complicating the practical handling of such smart cards when storing or deleting keys or otherwise restricting convenient use of the smart card on the other.

An object on which the present invention is based is to provide an improved technical concept for handling smart cards. The invention achieves this object via the subject matters of the independent claims. Dependent claims reflect preferred embodiments.

A first aspect of the present invention relates to a method for an interaction with a hardware token. The method may be implemented, for example, by an application for an end device, for instance a wallet app. The method comprises searching for an identification code using a digital certificate or based on a digital certificate; and initiating the interaction with the hardware token based on the (for example, sought) identification code.

The interaction may relate, for example, to the handling, use, etc. of the hardware token, during which data on the hardware token are manipulated. The data may relate to a digital key, in particular digital vehicle keys. The data may comprise, for example, an end point according to the CCC for a digital vehicle key. The interaction may comprise the application, writing, overwriting, deletion or other persistent manipulation of a digital key on the hardware token.

In some embodiments, the interaction may comprise key agreement, in particular password-authenticated key agreement or password-authenticated key exchange (PAKE), preferably a Simple PAKE (SPAKE) mechanism, particularly preferably a particular SPAKE mechanism, namely SPAKE2+.

In some embodiments, the hardware token (sometimes abbreviated to “HW token” here) may comprise a smart card, a chip card, a memory card etc., or otherwise an HW token or physical carrier, which, instead of a card format, may also have a different form factor, such as a USB token or a key fob. It is also conceivable that the HW token is in the form of an intelligent device, for example in the form of a smartphone or similar mobile device, on which an app, an applet etc. with a corresponding functionality is present.

The HW token may generally have a carrier structure, such as a card, a stick etc., wherein the structure incorporates, contains, includes, etc. a data memory, a chip, etc. If the carrier is designed, for example, as a memory card, this may be, for example, a plastic card, chip card, smart card, etc. with an integrated circuit (chip), a hardware logic circuit, a memory and/or a microprocessor. A memory of the HW token is designed to store at least one identification code, one digital certificate and one digital key.

The identification code may be a password, keyword, code word, a passphrase, (i.e., multiple passwords etc.), i.e., generally a sequence of symbols, such as characters, numerals, special characters (including spaces), etc. The interaction with the hardware token, for example the manipulation of a digital key, may be password-protected or, more generally, identification-code-protected; by way of example, a correspondingly specified key-exchange or key-agreement mechanism may stipulate that data manipulation may only be carried out with knowledge of the corresponding identification code, i.e., when the identification code is present, is known, is input, etc.

The digital certificate may comprise one certificate or it may comprise multiple certificates, for example in the form of a chain-of-trust with at least one intermediary certificate, root certificate and/or end certificate. In one embodiment, the digital certificate comprises an instance certificate, which relates, in particular, to the hardware token. By way of example, an instance certificate may confirm the identity of the hardware token itself, or it may confirm (an instance of) a certification point on the hardware token.

Embodiments of the method according to the first aspect of the invention may comprise prior reading-out of the certificate from the hardware token. Based on the read-out certificate (or a processing product, such as a hash value, an item of data from the data structure which represents the certificate, for example a number of the certificate, a represented public key etc.), it may then be checked whether the password (on the device side, or in a, for example, device-side backend system, a Cloud etc.) is known by attempting to search for the identification code.

Some of these embodiments may furthermore comprise ascertaining that the search for the identification code has failed (e.g., when the HW token is applied or used for the first time); and, in response to the ascertainment, initiating the receipt of the identification code (on the device side). Such receipt may comprise, for example, the input of the identification code by a person, the scanning of a QR code or some other way of capturing, reading-in etc. the identification code.

Some of these embodiments furthermore comprise initiating user confirmation before storing the received identification code, wherein the storage process may comprise, in particular, storing the identification code in association with the digital certificate (or in association with an item of data or a sub-combination of data of the certificate, a processing product, for instance a hash etc. of the digital certificate, etc.).

In some embodiments, the search for the identification code comprises searching in a password memory, a password manager, another repository for passwords, identification codes etc. The search for the identification code may comprise, in particular, searching in a device-side memory and/or in a remote memory. The device-side memory may be managed, for instance, by a keychain or another password service. The remote memory may comprise, for instance, a server- or cloud-based password memory. Such a memory may be operated, for instance, in a backend system, for example operated by a vehicle manufacturer, a device manufacturer, etc.

In some embodiments, the storage of the identification code comprises password or identification-code synchronization, via which identification codes or passwords for multiple devices of a user account are synchronized. Such synchronization may comprise loading a dataset containing an association between an identification code and a digital certificate (or part of the data of the certificate, a processing product, etc.) into a device-side password memory of one or more of the devices which are associated with the user account. In addition or alternatively, the association may also be stored in a password memory associated with the user account in a backend system, a cloud, etc.

Another further aspect of the present invention relates to a method for supporting a device-side interaction with a hardware token. The method may be implemented on a server, for example, in a device backend system, a device-manufacturer server etc. The method comprises receiving an association between an identification code and a digital certificate from a first device, wherein the certificate relates to the hardware token; and forwarding the association to at least one second device, wherein the first device and the second device are associated with the same user account.

A further aspect of the present invention relates to the use of a password memory or identification-code memory for storing an identification code, wherein a digital certificate may be used to search for the identification code. The certificate may relate to a hardware token and may comprise, in particular, an instance CA certificate relating to a CA on the HW token. Such a memory or manager may be equipped, for example, with a corresponding API (application programming interface) in order to search for an identification code, read out this identification code from the memory, read corresponding data sets into the memory or store them therein etc. based on a certificate. The memory or manager may also contain processing routines, for example in order to parse a data structure of the digital certificate, generate processing products, such as a hash value, etc.

Another further aspect of the present invention relates to a computer program product comprising program code segments for carrying out a method according to the first aspect of the invention as described herein when the computer program product is executed on a computer. The computer program product may relate, in particular, to an application or app, for example a wallet app, for an end device, user device, etc.

Another further aspect of the invention relates to an end device, which comprises a secure memory device for storing a digital key, an interface for interaction with a hardware token (such as an NFC interface), and a computer program product as described herein. Some embodiments of the end device moreover comprise a password memory as described herein.

One aspect of the present invention relates to a system, which comprises an HW token for storing a digital key as described herein. The system furthermore comprises an application for an end device, for example a wallet application, which is based on a computer program product described herein. The system may furthermore comprise a password memory as described herein, which is operated, for example, centrally, on a server, in a Cloud of a corresponding provider, or is operated in a backend system of a device manufacturer or a vehicle manufacturer etc.

The invention will now be described in greater detail with reference to the accompanying drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an exemplary embodiment of a system according to the invention;

FIG. 2 shows a flow chart for a first exemplary embodiment of a method according to the invention; and

FIG. 3 shows a flow chart for a second exemplary embodiment of a method according to the invention.

### DETAILED DESCRIPTION OF THE DRAWINGS

An end device or user device here is understood to be any device which implements an end point for an electronic communication, a communication network etc. and which is designed for use, operation etc. by a human user, a person, an operator, a service employee etc., for example via an HMI (human-machine interface). An end device may be, for example, a mobile device, a portable device, a wearable etc., for instance a notebook, tablet or smartphone, a smartwatch, a smartband, a smartring etc. Devices for stationary use, such as a PC, a service end device, an operating console etc. are also regarded as end devices.

Reference to an end device also includes an end device which will only become available in the future, provided this has the necessary processor capacities, storage space etc. for implementing an aspect according to the invention as is described herein.

An end device may comprise a secure memory or a secure environment, a secure element etc., for example on a corresponding chip, a crypto-processor etc. By way of example, the secure memory may be an HSM (hardware security module), TPM (trusted platform module), a secure element (secure enclave), a secure zone, a TEE (trusted execution environment) etc. The secure memory may hold a digital (vehicle) key, for example, which is to be shared to an HW token.

An HW token as described herein may be provided for an interaction, for instance reading-out, inscribing etc., using NFC technology. However, it should generally be possible for an interaction with an HW token to take place via any wireless, contactless and/or short-range technology which is known as such or is to be developed in the future, including, for example, Bluetooth, Bluetooth Low Energy, UWB (ultra-wide band), Firebird, WLAN (wireless LAN), RFID (radio frequency ID), iBeacon, etc. Embodiments of an HW token are also conceivable in which this token incorporates, for example, an identification code, a password etc. and/or further information in the form of a (one-dimensional) bar code, (two-dimensional) QR code etc., wherein such codes may be read out using active or passive sensors, for example based on sensors in the optical, ultraviolet and/or infrared range.

An interaction with an HW token may include a user, operator etc. holding the HW token against a reading device which may be integrated in a user device or which may also be separate from this, for example in the form of an NFC reading device connected to a PC or a reading device integrated in a motor vehicle.

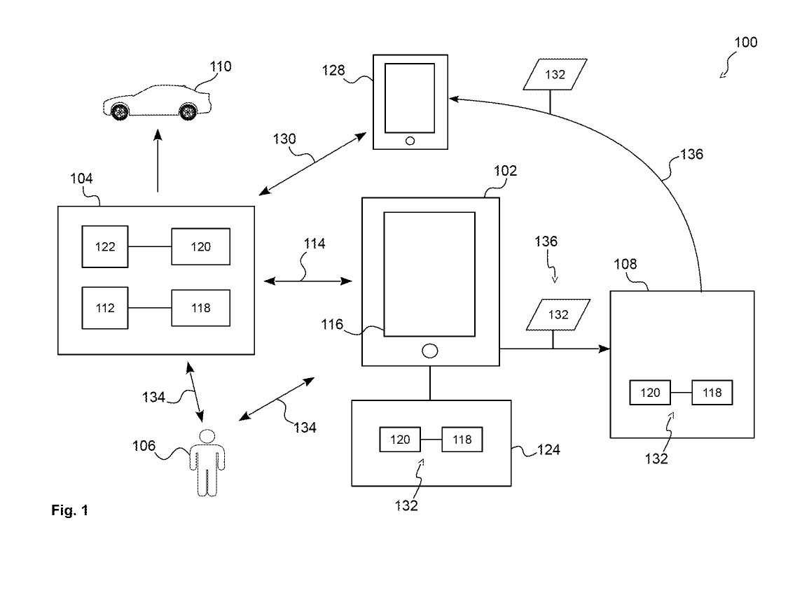

FIG. 1 shows, in schematic form, an exemplary embodiment of a system 100 having an end device 102 and a smart card 104, which are used by a user 106, and a server 108, which implements a backend system for the end device 102.

The end device or user device 102 may be a mobile device, such as a smartphone or a tablet, which is available to the user 106 for private or professional use. In one scenario, the user 106 is the proprietor or owner of a motor vehicle 110, and the user 106 has acquired the smart card 104 in blank or empty form from a manufacturer of the vehicle 110 or from a third-party provider in order to share a digital key 112 for the vehicle 110 from the user device 102 to the smart card 104. The smart card may simply serve, for example, as a duplicate key, spare key etc.

In another scenario, the user 106 may be an employee of a service provider, such as a vehicle hire company, and the smart card 104 with the vehicle key 112 shared thereto is to be handed over to a customer who is renting the vehicle 110. In each case, the smart card 104 is a general example of a hardware token which may serve as a practical, simple, convenient or expedient physical carrier of the digital vehicle key 112 in various usage scenarios. Accordingly, it should be possible to share the key 112 to the card 104 in a procedure which is likewise simple for the user 106, without compromising on the key-sharing security.

To share the vehicle key 112 to the smart card 104 via an interaction 114, an application 116 may be present in the end device 102, for example, in the form of a wallet app, known per se, which is trusted by a private user to make payments, etc. from his smartphone and which has been developed to carry out the interaction 114 according to the invention. However, when used in a vehicle hire company, etc., the end device 102 may also be implemented as a service end device at a service desk, and the smart card 104 is inscribed with the key 112 by the service employee 106, for example, via a stationary NFC interface, against which the card 104 is held before being handed out to a customer.

To enable the vehicle key 112 to be stored on the smart card 104 (and possibly to enable a different key previously stored on the card 104 to be deleted), a password-protected interaction is provided, more precisely a SPAKE2+ process, which is known as such to a person skilled in the art. This means, amongst other things, that, for each instance of writing, changing or manipulating data such as the vehicle key 112 on the smart card 104, the end device 102 or the wallet app 116 is required to know a password 118.

More precisely, valuable data such as the vehicle key 112 on the smart card 104 must naturally be protected against unauthorized manipulation, i.e., an access barrier must be provided before writing, overwriting, changing etc. such data. In order to protect data on a hardware token such as the smart card 104 against unwarranted or unauthorized manipulation, standardization is currently implemented by the CCC, according to which a particular algorithm for a password-authenticated key agreement, namely SPAKE2+, is required for access to, or interaction with, a hardware token.

With respect to the example illustrated in FIG. 1, this specifically means that, for each interaction (such as the interaction 114) with the smart card 104, in order to teach-in or introduce a new end point (e.g., for the digital key 112), or to end and delete an end point, the password 118 must be known by the end device 102. Generally speaking, for each command with which data (such as data of a data structure which represents the digital key 112) on the smart card 104 are to be manipulated, a password such as the password 118 must be known by a device for managing the HW token or the smart card 104 (i.e., the end device 102 with the wallet app 116 from which the digital key 112 is to be shared to the smart card 104, for example).

However, the (repeated) input of a password is tiresome for the user 106. (Repeated) scanning of a QR code is also tiresome, even if the code is printed on the smart card 104, for example, since this requires the card 104 to be held so that the code can be scanned, whereas, prior to this and following this, the card 104 must be held so that NFC-based communication may take place. Such handling of the end device 102 and smart card 104 (indicated in general by the reference sign 134 in FIG. 1) may be seen as tiresome in the case of private use. This applies all the more, for example, when handling many smart cards (for multiple vehicles), for instance at a service desk; i.e., in a commercial environment, dealing with many cards may be regarded as time-consuming and complicated if it is necessary to communicate with customers at the same time etc.

There is therefore a need to facilitate the handling of an HW token such as the smart card 104 for an interaction such as the data manipulation of data on the card 104, albeit without compromising on security in the process (i.e., unauthorized manipulation of the vehicle key 112 on the smart card 104, for example, should continue to be reliably prevented).

Exemplary embodiments of the invention aim to ensure that a single user (or a group of users who are logged into a commercial user account, for example) only has to input or scan a password or other identification code for an HW token once.

In some of these exemplary embodiments, an instance CA certificate of the hardware token is used as an identifying element. In the example shown in FIG. 1, a certificate 120 confirms the identity of a certification point 122 on the smart card 104. More precisely, the certificate 120 (possibly following confirmation by the user 106) together with the SPAKE2+ password 118 may be stored in a password memory 124 which (in this example) is implemented locally on the end device 102. The password memory or manager 124 may be, for example, a keychain or a similar product, as provided both by manufacturers of end devices and also other providers.

Whenever the end device 102 interacts with a hardware token such as the smart card 104, the end device 102 may attempt to read certificates such as the instance CA certificate 120 from the smart card 104 in order to check, based on this, whether a password such as the password 118 is known. If the password 118 is not known (for example, because it has not been found in the password memory 124), the user 106 must input or scan the password 118. On the other hand, if the password 118 is already known, the device 102 (more precisely the wallet app 116) enables key sharing or other data manipulation directly. In the example shown, for example, key sharing of the digital key 112 to the smart card 104 may take place without the user 106 having to input the password 118 again.

Exemplary embodiments of the invention furthermore propose that the backend server 108, which may be operated by a manufacturer of the end device 102, for example, synchronizes relevant information relating to the smart card 104 (such as the instance CA certificate 120 and the password 118) between the device 102 and at least one further device 128 of the same user 106. This enables wireless use of the information over all devices 102, 128 which are associated with the same user account (i.e., a smartphone, tablet and/or a smartwatch of a private user, or multiple service end devices of a commercial user, for example). In other words, once the password 118 has been input for one interaction 114, for example, there is no need to input the password again for further interactions 114 or 130 of devices 102, 128 with the smart card 104.

A person skilled in the art will understand that a PKI (public key infrastructure), for example in the form of a certification point, instance, certification instance, CA (certificate authority) etc., may be present on the smart card 104 for issuing further certificates (a corresponding root element may comprise, for example, only one cryptographic key, one private key segment, one certificate etc.). The smart card 104 may be correspondingly designed for storing a plurality of digital certificates, for example intermediary certificates, instance CA certificates such as the certificate 120, root certificates, etc.

It is also conceivable that multiple certification points are present on the smart card 104, i.e., at least one further CA in addition to the CA 122. It is likewise conceivable that a certificate does not relate to the CA 122 (or another CA), but, for example, to a serial number, ID number, etc. of the smart card 104.

However, if, for the (or each) interaction 114 with the smart card 104, the end device 102 or the wallet app 116 reads out the instance CA certificate 120 from the smart card 104, the validity of the certificate 120 may be checked, for example, by checking a chain-of-trust for the certificate 120, wherein the chain-of-trust or certificate of a root CA of a device manufacturer (of the end device 102) may comprise a root CA of a vehicle manufacturer (of the vehicle 110) and/or a root CA operated by the CCC. The validity, trustworthiness or usability of the CA 122, the smart card 104 and/or the digital key 112 may therefore be ascertained in a simple manner. In other words, it is easily possible for device manufacturers and/or vehicle manufacturers to block the card 104 from further use or to make it unusable by no longer permitting further data manipulations.

Where it is stated herein that a hardware token such as the certificate 120 is stored in a password memory such as the memory 124, or the identification code or the password 118 is sought using or based on the certificate 120 stored (in the memory 124), this should also include exemplary embodiments in which, in addition or as an alternative to storing the entire certificate 120, only part or parts of the corresponding data structure are stored (for example, a number or ID of the certificate or a public key) and/or in which a processing product such as a hash value relating to the certificate or parts thereof is stored and used to search for the password 118. The important thing is that the stored segments of the certificate 120 may be clearly associated with the HW token or the smart card 104.

In some exemplary embodiments, the password memory 124 may be specifically designed to read-in the certificate 120, to read-in or to store the certificate 120 and password 118 in association with one another and/or to search for the password 118 based on the certificate 120. By way of example, the password memory 124 may be configured to only accept a request based on a certificate, such as the certificate 120, from the wallet app 116.

Some exemplary embodiments of the invention comprise password synchronization, in which the association 132 between the certificate 120 and password 118, for example, after being stored in the password memory 124 of the end device 102, is transferred to a password memory of the further end device 128 and stored therein. The password synchronization may take place, for example, using a central instance, for example, a central password memory, which is located in a dedicated server, in a Cloud or the like.

In a simple exemplary embodiment, the association 132 may be distributed to the at least one further end device 128 of the same user account via the backend server (device-manufacturer server) 108 (for example, the password memory 124 may be provided by the manufacturer of the end device 102). In this procedure, synchronization may be carried out in a simple manner since devices of the same manufacturer are generally compatible in terms of wallet app, password memory, synchronization mechanism 136, etc. Alternatively, the password memory of another, for example specialized, provider could be used, which carries out synchronization via a corresponding server, wherein the provider might be authorized or certified by the CCC, for example. However, the end devices which are to be included in the synchronization would have to be explicitly indicated here.

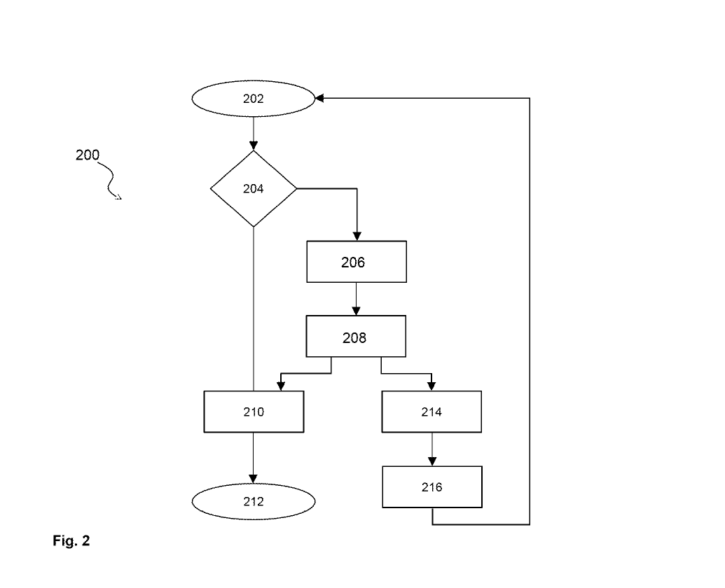

An exemplary embodiment of a specific procedure for the interaction 114 between the wallet app 116 and the smart card 104 will be described in greater detail below with reference to the procedure 200 shown schematically in FIG. 2.

A procedure begins in a step 202 so that the instance CA certificate 120 is read out from the smart card 104. In a step 204, the password 118 is sought in the password memory 124 using the read-out certificate 120. More precisely, an attempt is made to find the password 118 in the password memory 124. In a step 206, it is ascertained that the search for the password 118 has failed. By way of example, it might not be possible to search for the password 118 in the memory 124 since the certificate 120 is not contained in a search index for the password memory 124.

In response to the ascertainment in step 206, receipt of the password 118 at the end device 102 is initiated in a step 208, for example, in that the user 106 inputs the password 118 at the end device 102 or scans a QR code. In a step 210, the actual interaction with the smart card 104 is initiated based on the received password 118, for example, a SPAKE2+ procedure is successfully followed. In a step 212, the manipulation of data on the smart card 104 then takes place, whereby the digital key 112 is shared to the smart card 104, for example.

In a parallel step 214, user confirmation is obtained so that, in a step 216, the received password 118 (in association with the digital certificate 120) is stored in the password memory 124. The step 216 may likewise comprise password synchronization with the further end device 128.

If the method 200 is then followed again at a later time, the step 204 of searching for the password 118 based on the certificate 120 proceeds successfully. The steps 210 and 212 for the data manipulation are then followed immediately thereafter; for example, the key 112 may be overwritten or changed without the user 106 having to input or scan the password 118 again.

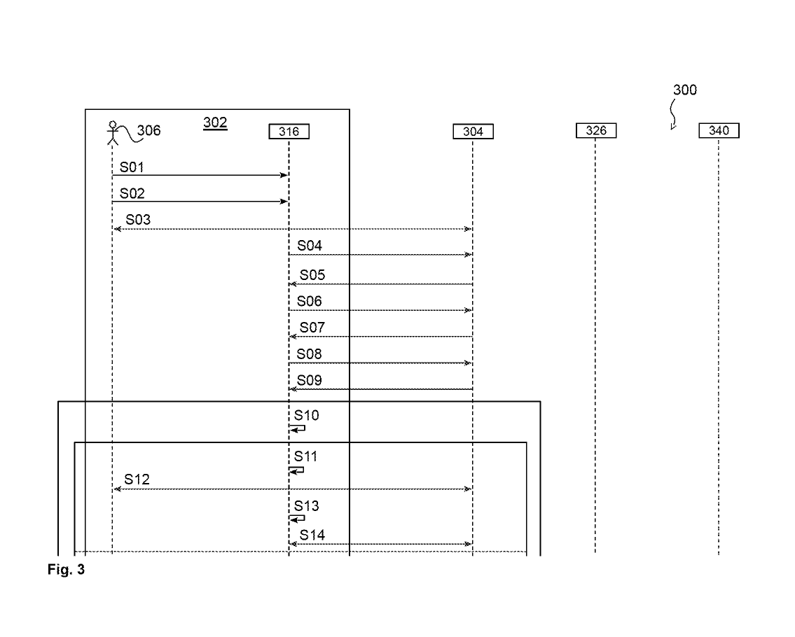

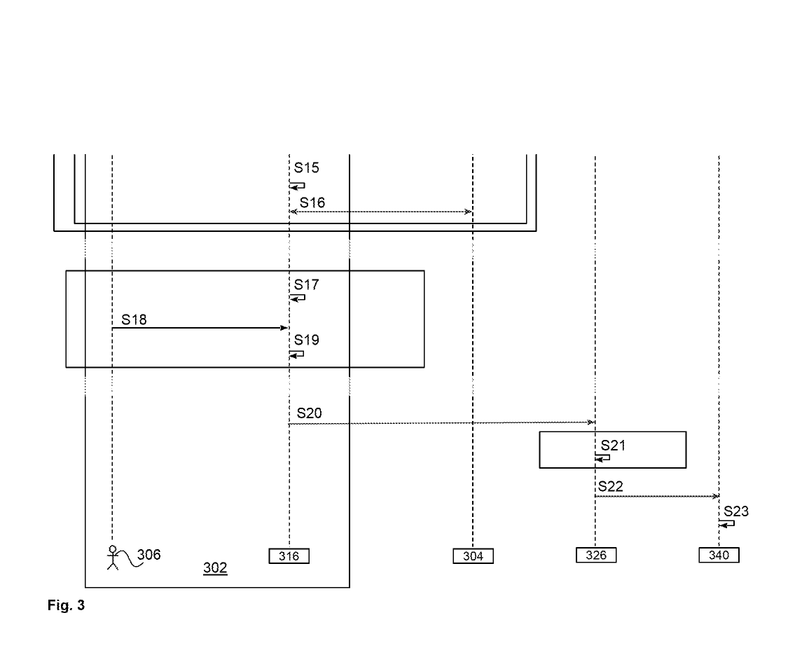

FIG. 3 shows, in the form of a schematic flow chart, a further exemplary embodiment of a method 300 for an interaction between a sharing end device or user device 302 (and in particular a wallet app 316 on the end device 302) and a hardware token 304. A device-manufacturer server 326 and (at least) one other device 340 of a user 306 of the end device 302 are furthermore involved in the method 300. In other words, the devices 302 and 340 are associated with the same user account; for example, they are logged into a private user account of the user 306 or into a commercial user account of a company, for example, a car hire company, where the user 306 is an employee of the company, i.e., the user 306 has signed into the device 302 from an account of the employer and the user 306 or another employee has signed into the device 340 from the same account.

Generally speaking, the end device 302 (or 340), wallet app 316, hardware token 304 and device-manufacturer server 326 may each be a respective exemplary embodiment of the end device 102, the wallet app 116, the smart card 140 or the device-manufacturer server 108 of FIG. 1; please refer to the relevant description in each case.

The hardware token 304 may be, for instance, a password-protected key card (smart card). More precisely, the method 300 relates to the handling of the hardware token 304, protected by SPAKE2+, in a manner which is convenient and expedient for the user 306, in particular in terms of the manipulation of data on the hardware token 304, such as key sharing, i.e., writing, modifying, deleting or overwriting a digital key on the hardware token 304.

In the example described here, a digital key is to be shared from the wallet app 316 to the hardware token 304. The scenario according to the invention relates to the caching and synchronization of the SPAKE2+ password when the password-protected hardware token 304 is used for the first time.

In a step S01, the user 306 selects the digital key to be shared in the wallet app 316. In a step S02, the user 306 initiates key sharing, i.e., selects, for example, a process such as “share key to card”. In a step S03, the user 306 places the hardware token 304 on an NFC interface of the sharing end device 302.

In a step S04, the wallet app 316 sends a SELECT command relating to a management applet to the hardware token 304. In a step S05, the hardware token returns a corresponding SELECT response tag. In a step S06, the wallet app 316 sends a VIEW command to the hardware token 304, which relates to an instance CA certificate and further certificates of the corresponding chain-of-trust. In a step S07, the hardware token returns a corresponding VIEW response. In a step S08, the wallet app 316 sends a READ-BUFFER command of corresponding length to the hardware token 304. In a step S09, the hardware token returns a corresponding READ-BUFFER response to the wallet app 316.

The steps S10 - S16 relate to the handling of a password between the end device 302 and the hardware token 304. The steps S10 - S14 describe a procedure in which key sharing from the sharing device 302 to the hardware token 304 is carried out for the first time, i.e., the password for the hardware token 304 is not known in the end device 302. The steps S15 - S16 describe a procedure for subsequent key sharing, for example, in which the password for the hardware token 304 is already known.

In step S10, the wallet app 316 searches for a SPAKE2+ password for the instance CA certificate read out from the hardware token 304. The password may be sought on the device side in a password memory of the sharing device 302; or an external or remote password memory, for example in a backend system, may be contacted for the search. In an exemplary embodiment, the two may be combined, for example a local search may be carried out first and, if the result is negative, an external search may take place, i.e. a search request may be sent externally.

In step S11, the wallet app 316 instigates the output of information to the user 306, which indicates that the password of the hardware token 304 is not known. The information may furthermore contain a request, for example to scan a QR code of the hardware token 304. The user 306, in a step S12, may then scan a QR code from the card or from the hardware token 304. The QR code may contain the SPAKE2+ password. In addition or alternatively, the password may also be provided in another way, for example on paper, and the user 306 inputs the password into the end device 302.

Once the password has been accepted, the wallet app 316, in a step S13, instigates the output of information to the user 306, which requests that the hardware token 304 be held against the NFC reader. In step S14, the input or scanned password is then used to establish a channel, secured by SPAKE2+, between the sharing device 302 and the hardware token 304.

If the password of the hardware token 304 is already known, the procedure is different according to the invention. In step S15, the wallet app 316 again searches for a SPAKE2+ password using the instance CA certificate, read out from the hardware token 304, in a password memory, a keychain, etc. The search is successful. This step may also require explicit user authentication, for example if this has not already taken place in the key sharing procedure. The password does not need to be input or scanned. In step S16, the sought password is then used to form a channel, secured by SPAKE2+, between the sharing device 302 and the hardware token 304.

Further key sharing to the hardware token 304 may take place according to a procedure which is known per se. Steps S17 - S19, indicated in FIG. 4, which describe storing the input or scanned password, may be embedded in this procedure. In step S17, the wallet app 316 instigates the output of information to the user 306, which indicates that the key sharing to the hardware token 304 was successful and asks whether the password of the hardware token 304 should be stored. In step S18, the user 306 may agree to storing the password. In step S19, the password memory (keychain etc.) is updated, specifically with the instance CA certificate and the SPAKE2+ password in searchable association with one another.

The steps S20 - S23 relate to the synchronization of the password between the end device 302 or wallet app 316 and the device-manufacturer server 326 and user device 340. Various options may be considered for password synchronization. In this regard, the password stored locally in the user device 302 may be passed to the device-manufacturer server 326 in order to achieve synchronization with further devices, such as the device 340, associated with the same user account via the server 326. A synchronization mechanism between devices 302, 340 of the same manufacturer and/or user account may take place, for example, via a Cloud solution (e.g., iCloud, Google Drive) provided by the device manufacturer. In addition or alternatively, a distributed and/or central password memory may also be operated by a third party (e.g., CCC).

In detail, in step S20, the wallet app 316 sends information relating to the synchronization of the known password to the device-manufacturer server 326. The optional step S21 relates to storing the password in a remote memory, i.e. a password memory on the device-manufacturer server 326, in a Cloud, etc.

In step S22, the device-manufacturer server 326 sends information relating to the synchronization of the known password to the at least one further user device 340. In step S23, the at least one further user device 340 updates its local password memory.

Exemplary embodiments of the invention can be used for smart cards and, in general, for hardware tokens, which are useful in various scenarios by serving as physical carriers for digital data or assets such as digital vehicle keys. Accordingly, it should be possible to share a digital key to a hardware token in a simple manner, without reducing the protection of the key on the token against unauthorized manipulation.

Exemplary embodiments of the invention propose configurations of methods, known per se, for password-protected key exchange (the term “key” relates here to a key which is agreed between partners of the key exchange process in order to establish a secure channel between the partners). Such processes are proposed, for example, by the CCC for safeguarding data manipulations on an HW token. For such processes, however, a password must be known on both sides (e.g., the token and the sharing end device). In practice, this may hinder or complicate the handling of the HW token, make it more susceptible to errors, increase the time needed for key sharing, etc. and go as far as restricting the acceptance of tokens such as smart cards for the users.

Exemplary embodiments of the invention enable a situation in which, once an identification code or password has been entered once, this identification code or password does not have to be input again; this applies to the relevant token and to a user with his end device or end devices and, more generally, to a plurality of end devices which are logged into one account, for example, and are used by multiple people (a group of devices which do not require or need the password to be input again, but which can also be defined in a different way, for example based on a correspondingly configured synchronization algorithm).

Exemplary embodiments of the invention ensure the same high security standard, since the actual security mechanism for enabling authorized data manipulation and preventing unauthorized data manipulation remains unchanged for the initial access to an HW token and for subsequent access. The identification code, once known, is made persistent and this can and should take place with a level of security equivalent to that for the data manipulation. Exemplary embodiments of the invention propose storing the identification code in a correspondingly secure password memory, and corresponding storage may take place locally, centrally and/or in a distributed manner.

Exemplary embodiments in which an HW token, such as a new smart card, is used for the first time, for instance in a relatively small commercial business, may be correspondingly advantageous and expedient: In this case, the password must be input or scanned once, and then, for optimized user convenience and benefit, the password for this card does not need to be input again across the business, yet the card still functions reliably and the data on the card, for example a digital vehicle key (or repeatedly changing vehicle keys), are secure.

Exemplary embodiments of this type are suitable for promoting the acceptance and distribution of digital data or assets such as digital vehicle keys, which may in turn contribute to cost savings compared to conventional methods for handling analog or digital assets with a similar level of security.

Exemplary embodiments of the invention propose using a digital certificate of the HW token for indexing the identification code or password. To this end, an instance CA certificate of a CA may be used particularly advantageously on the token. This enables not only clear identification of the card and the associated password, but it is, in principle, possible to hold or manage different data sets, each with different identification codes or passwords, on one card. Moreover, with regard to a CA, trusted authorities in a chain-of-trust, such as device manufacturers and/or vehicle manufacturers, may easily block a token from further use, and this also increases the security of the data on an HW token.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### List of reference signs

100 System

102 End device, user device

104 Smart card, card

106 User

108 Device-manufacturer server

110 (Motor) vehicle

112 Digital key

114 Interaction, end device 102 / smart card 104

116 Wallet app

118 Password

120 Certificate

122 CA, certification point

124 Password memory

128 Further end device

130 Interaction, further device / smart card

132 Association, certificate / password

134 Handling of smart card and end device

136 Synchronization

200 Method

202-216 Steps of the method

300 Method

302 End device

304 Hardware token

306 User

316 Wallet app

326 Device-manufacturer server

340 Further end device

S01-S23 Steps of the method

What is claimed is:

1. A method for an interaction with a hardware token, the method comprising:
searching for an identification code based on a digital certificate; and
initiating the interaction with the hardware token based on the identification code.

2. The method according to claim 1, wherein the digital certificate relates to the hardware token.

3. The method according to claim 2, wherein the digital certificate relates to a certification point on the hardware token.

4. The method according to claim 1, comprising a prior step of reading out the certificate from the hardware token.

5. The method according to claim 2, comprising a prior step of reading out the certificate from the hardware token.

6. The method according to claim 3, comprising a prior step of reading out the certificate from the hardware token.

7. The method according to claim 4, further comprising:
ascertaining that the search for the identification code has failed; and
in response to the ascertaining, initiating receipt of the identification code.

8. The method according to claim 7, further comprising:
initiating user confirmation before storing the received identification code.

9. The method according to claim 8, wherein the storage process comprises synchronization.

10. The method according to claim 1, wherein the searching for the identification code comprises searching in a password memory.

11. The method according to claim 2, wherein the searching for the identification code comprises searching in a password memory.

12. The method according to claim 10, wherein the searching for the identification code comprises searching in a device-side memory or a remote memory.

13. The method according to claim 1, wherein the interaction comprises a manipulation of data on the hardware token.

14. The method according to claim 13, wherein the data relate to a digital key.

15. The method according to claim 1, wherein the interaction relates to key sharing to the hardware token.

16. The method according to claim 1, wherein the interaction comprises a password-authenticated key agreement or a password-authenticated key exchange.

17. The method according to claim 1, wherein the identification code is stored in a password memory, and the identification code is retrievable using a digital certificate.

18. A computer program product comprising program code segments, which when executed on a computer cause the computer program product to carrying out a method according to claim 1.

19. An apparatus comprising:
a secure memory for storing a digital key;
an interface for an interaction with an HW token; and
a computer program product according to claim 18.

20. A system comprising:
a hardware token for storing a digital key; and
an application for an end device based on a computer program product according to claim 18.
